(19) United States
(12) Patent Application Publication
(10) Pub. No.: US 2024/0029124 A1
(43) Pub. Date: Jan. 25, 2024

(54) METHODS AND SYSTEMS FOR AIDING A USER TO SELECT DOCUMENTS BASED ON INPUT PARAMETERS

(71) Applicant: CDK GLOBAL, LLC, Hoffman Estates, IL (US)

(72) Inventors: Winn Davis, Houston, TX (US); Daniel Green, Albany, OR (US); Ethan Heusser, Portland, OR (US); William Padron, Pembroke Pines, FL (US); Bruce Suitor, Rockville, MD (US)

(21) Appl. No.: 17/814,012

(22) Filed: Jul. 21, 2022

(51) Int. Cl. G06Q 30/06; G06F 16/93; G06F 9/451; G06F 16/23

(52) U.S. Cl. CPC G06Q 30/06; G06F 16/93; G06F 9/453; G06F 16/2379

(57) ABSTRACT

Examples described herein include methods, techniques, and systems that aid a user in selecting one or more documents of a plurality of documents to complete an instant transaction. In some embodiments, a method may include receiving, from the user, one or more parameters associated with the instant transaction. The method may also include accessing data of one or more completed transactions over a past time period. Based on the one or more parameters received from the user, the method includes determining a confidence threshold of each document of the plurality of documents needed to complete the instant transaction. The method may also include receiving, from the user, a desired confidence threshold of the one or more documents of the plurality of documents to complete the instant transaction. Based on the desired confidence threshold, the method may include automatically listing the one or more documents to complete the instant transaction.

### BACKGROUND

Automotive, real estate, financial, insurance, and/or other industries may often require a person (a buyer, a customer, a client, a borrower, etc.) to sign numerous documents (or forms) to complete a transaction. Even within a particular industry, the documents needed to complete a transaction may differ depending on the type of the deal. For example, in the automotive industry, automotive dealerships (e.g., car dealerships, vehicle dealerships) may complete a considerable count of transactions, such as selling, buying, trading in, and/or repairing vehicles. Each of these transactions may require a customer who may be selling, buying, trading in, and/or repairing one or more vehicles at a car dealership to receive and/or sign one or more documents.

In the case of the automotive industry, the customer usually relies on a user (e.g., a person, a salesperson, a car salesperson) associated with, and/or working at, a car dealership to select the proper documents required to complete the transaction, for example, based on the type of the deal and/or customer input. To select the proper documents, the salesperson may use a computer to find the proper documents from a plurality of documents. The salesperson may then print, email, fax, and/or the present the proper documents to the customer or another person (e.g., a banker, a department of motor vehicles (DMV)) associated with the transaction and/or the deal. Furthermore, the customer, the automotive industry, and/or the car dealership may require that the salesperson selects the proper documents and helps fill out the documents in real time (e.g., quickly and/or without prior notice).

Unfortunately, current methods and/or systems used to select the proper documents to complete a transaction may be complex, time consuming, and/or prone to human error. Due to errors, the salesperson may need to perform a “rewrite” of the transaction in a future time period to correct mistakes made during the completion of the transaction. Also, due to an increased time to complete the transaction, the customer may elect to cancel the transaction and/or the deal. Therefore, the car dealership may lose the vehicle sale and/or may lose the trust of the customer. As a result, the customer may choose to purchase their vehicle at a competitor of the car dealership. Additionally, or alternatively, the customer may post and/or publish a complaint (e.g., on a website with crowd-sourced reviews), and/or tell their friends, colleagues, and/or family regarding the unpleasant and/or unsatisfying experience with the car dealership.

To navigate and/or manage the complexity of the transaction(s), decrease the time it takes to complete the transaction(s), and/or reduce errors to complete the transaction(s), the car dealership may invest considerable resources to set up a system (e.g., a dealer management system (DMS)) used to complete transactions involving a considerable count of deal types, where each transaction associated with each deal type may require different documents.

Unfortunately, even with a considerable investment to the setup of the system, the salesperson may still find the transaction process to be complex, time consuming, and/or prone to human error, in part, due to a continuous need to make changes to the setup of the current system. The changes to the setup may be due to changes in local, state, federal, national, and/or international requirements, policies, and/or laws; changes in best practices and/or requirements of the automotive industry; changes in the staff, salespersons, and/or management of the car dealership; changes in the business needs of the car dealership; and/or any other factors that may adversely affect selecting the proper documents to complete the transaction.

### BRIEF DESCRIPTION OF THE DRAWINGS

FIG. 1 illustrates an environment of a user utilizing a user device to select one or more documents of a plurality of documents to complete an instant transaction in accordance with examples described herein.

FIG. 2 illustrates an environment of an example computing device accessing data that may be stored in a database in accordance with examples described herein.

FIG. 3 illustrates an environment of a document selection module, which aids the user in selecting the one or more documents of the plurality of documents to complete the instant transaction in accordance with examples described herein.

FIGS. 4A, 4B, and 4C are example illustrations of an example graphic user interface, which may aid the user in selecting the one or more documents of the plurality of documents to complete the instant transaction in accordance with examples described herein.

### DETAILED DESCRIPTION

Examples described herein include methods, techniques, and systems that aid a user in selecting one or more documents of a plurality of documents to complete a financial transaction (or an instant transaction). The user may be working in a variety of establishments associated with a variety of industries, such as the automotive, real estate, financial, insurance, and/or other industries. Depending on the industry, the user may be a salesperson, a law professional, a manager, an agent, or any person who may interact with a buyer, a customer, or a client. In addition to interacting with the buyer, the customer, or the client, the user may also interact with a third party, such as a financial institution, a government agency, or any third party that may have an interest or role in the instant transaction.

In a case when the establishment is a car dealership, the salesperson may utilize the methods, techniques, and systems to find and complete the correct documents (e.g., one or more documents) that enable the salesperson to find funding (e.g., procure a loan) for a transaction with a customer. The transaction may include selling, buying, trading in, and/or repairing of one or more vehicles. In addition, the salesperson may utilize the methods, techniques, and systems needed to find and complete the correct documents to meet or exceed, for example, local, state, federal, national, and/or international requirements, policies, and/or laws; best practices and/or requirements of the automotive industry; the needs of the customer; the business needs of the car dealership; and/or any other requirements.

The documents may be electronic documents and/or printed documents. Note that electronic documents may decrease the time it takes to complete the instant transaction. The described methods, techniques, and systems may enable the user to complete transactions involving a considerable monetary value(s) (e.g., over $100,000, over €100,000) within a relatively short time period (e.g., within one hour, within two hours, within eight hours). Furthermore, the described methods, techniques, and systems may be used to complete the transactions more quickly, properly, and/or without rewrites. Such transactions benefit the car dealership, the customer, the lender (e.g., a bank, a financial institution), the original equipment manufacturer (OEM) (e.g., the vehicle manufacturer), the industry (e.g., the automotive industry), and/or the economy of a nation, state, city, municipality, and/or a combination thereof.

In one aspect, a computer-implemented method may aid a user in selecting one or more documents of a plurality of documents to complete an instant transaction. The computer-implemented method may include receiving, from the user, one or more parameters associated with the instant transaction. In the case of a car dealership, the parameters may include a transaction type, a financial institution, a stock type, a buyer type, a co-buyer status, a first trade-in status of a first vehicle, a second trade-in status of a second vehicle, a first loan status of the first vehicle, a second loan status of the second vehicle, a mechanical breakdown insurance (MBI) status, a buyer residence jurisdiction, a vehicle dealership jurisdiction, or a combination thereof. The computer-implemented method may also include accessing data of one or more completed transactions over a past time period, where each completed transaction includes the parameters. Based on the parameters received from the user, the computer-implemented method includes determining a confidence threshold of each document of the plurality of documents needed to complete the instant transaction. The computer-implemented method may also include receiving, from the user, a desired confidence threshold of the one or more documents to complete the instant transaction. Based on the desired confidence threshold, the computer-implemented method includes automatically selecting the one or more documents to complete the instant transaction.

In one aspect, a system may include a database, and the database may include one or more parameters, a plurality of documents, and a plurality of completed transactions. Each completed transaction includes a first value of each of the parameters and the specific documents used in each completed transaction. The system may also include a network interface, a processor, and a computer-readable medium. The computer-readable medium may include instructions that, when executed by the processor, configure the system to accept input from a user, where the user input may include a second value of each of the parameters associated with an instant transaction. The instructions may also configure the system to access, using the network interface, the plurality of completed transactions from the database. The instructions may also configure the system to compare the first value to the second value of each of the parameters. Based on the comparison, the instructions may also configure the system to automatically list (e.g., display on a display screen of a user device) the correct documents to be used to complete the instant transaction.

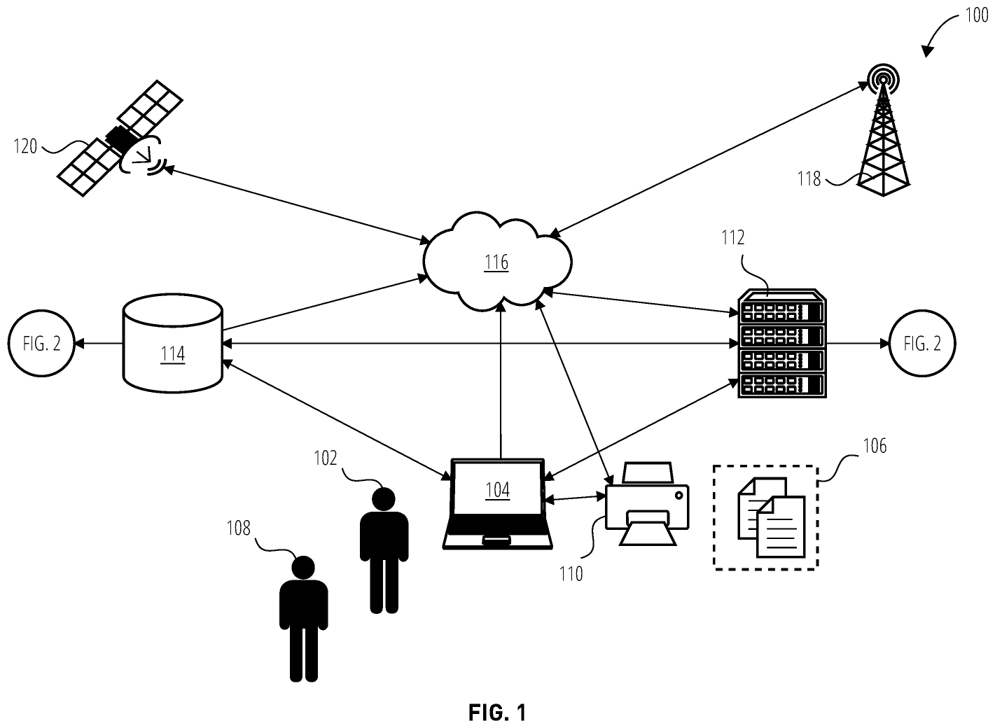

FIG. 1 illustrates an environment 100 of a user 102 utilizing a user device 104 to select one or more documents 106 of a plurality of documents to complete a transaction in accordance with examples described herein. Generally, the user 102 may be associated with, and/or work at, an establishment of any industry, such as the automotive, real estate, financial, insurance and/or other industries. For brevity, however, FIG. 1 and/or any other figure in this disclosure is described in the context of the establishment being a car dealership. Therefore, in some embodiments, the user 102 of FIG. 1 may be a salesperson, a sales manager, a financer, a finance manager, a customer service representative, a car lot manager, a car dealership manager, a car dealership owner and/or another person working at, or associated with, the car dealership.

In some embodiments, a person 108 (a buyer, a customer, a client, a borrower, and/or an owner of a vehicle, etc.) may interact with the user 102 (e.g., the salesperson) to sell, buy, trade in, lease, and/or repair one or more vehicles. To complete a transaction related to the selling, buying, trading in, leasing, and/or repairing of the vehicle(s), the user 102 may initially gather some information from the person 108. In some embodiments, the information may be one or more parameters. Depending on the parameters, the user 102, the person 108, and/or another person (e.g., a banker, not illustrated in FIG. 1) may need to review, fill out, and/or sign one or more documents 106 of a plurality of documents (not illustrated in FIG. 1). A count of the plurality of documents, however, may be considerably high (e.g., 100, 150, and so forth), and the one or more documents 106 of the plurality of documents that may be required to complete the transaction may, in part, depend on the type of the deal and/or the parameters. Furthermore, each of the plurality of documents may include one or more versions (e.g., document versions, form versions). Consequently, the version(s) of the one or more documents may change depending on the parameters; the date of the transaction; changes in local, state, federal, national, and/or international requirements, policies, and/or laws;

changes in best practices and/or requirements of the automotive industry; changes in the business needs of the car dealership; and/or other factors.

In some embodiments, the user 102 may need to select the proper documents and the proper versions of the documents (e.g., one or more documents 106) to complete a transaction in real time (e.g., quickly and/or without prior notice). Therefore, in some embodiments, the transaction may be referred to as an instant transaction that may occur in a current time period, a future time period (e.g., within 24 hours), and/or a near future time period (e.g., within one hour). Since the person 108 may be waiting for the user 102 to gather the one or more documents 106 to complete the instant transaction, it behooves the establishment (e.g., the car dealership) that the user 102 completes the instant transaction correctly and in a considerably reduced time period compared to, for example, using conventional (e.g., prior art, existing) techniques, using a checklist (e.g., electronic or paper checklist), and so forth.

The user 102 may utilize the user device 104 to select the one or more documents 106 that may be required to complete the instant transaction. In FIG. 1, the user device 104 is illustrated as being a laptop computer. Nevertheless, the user device 104 may be any other user device, such as a desktop computer, a smartphone, a wearable device, a notebook, and/or other examples of user devices that enable the user 102 to select the one or more documents 106 to complete the instant transaction.

The one or more documents 106 may be electronic documents or forms (e-documents or e-forms), printed documents, or a combination thereof. In a case of printed documents, the user 102 may instruct, for example, using a graphic user interface (GUI), the user device 104 to print each, a portion of, or all of the one or more documents 106 using a printer 110. In a case of electronic documents, the user 102 may instruct the user device 104 to transmit, file (save in a repository), report, or a combination thereof the one or more documents 106. For example, the user 102 may utilize the user device 104 to email the one or more documents 106 to an email address associated with the person 108, and the person 108 may review, sign, date, initial, and/or so forth the one or more documents 106 that are associated with the instant transaction. As another example, the user 102 may utilize the user device 104 to email the one or more documents 106 to a banker, a loan officer, or another financial worker. As yet another example, the user 102 may utilize the user device 104 to email the one or more documents 106 to a state's department of motor vehicles (DMV).

In some embodiments, the establishment (e.g., the car dealership) may utilize other user devices similar to, same as, or equivalent to the user device 104. For example, a plurality of salespersons (e.g., similar to the user 102) may simultaneously serve and/or help a plurality of customers (e.g., similar to the person 108). In some embodiments, each of the user devices (including the user device 104) may communicate with a centralized computing device 112 associated with the car dealership (referred herein as “computing device 112”). The computing device 112 may include hardware and software resources to correlate the one or more parameters, the instant transaction, completed transactions over a past time period, the one or more documents 106, and/or the plurality of documents (not illustrated in FIG. 1).

In some embodiments, the car dealership may utilize a database(s) 114 to store (e.g., electronically store) the instant transaction, the completed transaction, the parameters, the one or more documents 106, and/or the plurality of documents. In such a case, when the user 102 may be completing an instant transaction by using the user device 104 and/or the computing device 112, the user device 104 and/or the computing device 112 may first access data of one or more completed transactions over the past time period that may be stored in the database(s) 114. The completed transactions stored in the database(s) 114 may include the parameter(s) and the documents (e.g., the one or more documents 106 or other documents of the plurality of documents) associated with completed transactions over a past time period. Similarly, in some embodiments, the user 102 may utilize the user device 104 and/or the computing device 112 to transmit the selected documents (e.g., the one or more documents 106) associated with the instant transaction to the database(s) 114.

FIG. 1 illustrates the user device 104, the computing device 112, and the database(s) 114 as being distinct (or separate) entities. Nevertheless, the user device 104, the computing device 112, and the database(s) 114 may be integrated, for example, in one device. Additionally, or alternatively, the user device 104 may be inside the establishment (e.g., inside a building of the car dealership), while the computing device 112 and/or the database(s) 114 may be on a server that may be outside the establishment.

In some embodiments, the various devices and/or entities in the environment 100 may communicate with each other directly and/or via a network 116. The network 116 may facilitate communication between the user device 104, the printer 110, the computing device 112, the database(s) 114, a base station(s) 118, a satellite(s) 120, and/or other components (e.g., other user devices) that may not be explicitly illustrated in FIG. 1. Communication(s) in the environment 100 of FIG. 1 may be performed using various protocols and/or standards. Examples of such protocols and standards include: a 3rd Generation Partnership Project (3GPP) Long-Term Evolution (LTE) standard, such as a 4th Generation (4G) or a 5th Generation (5G) cellular standard; an Institute of Electrical and Electronics Engineers (IEEE) 802.11 standard, such as IEEE 802.11g, ac, ax, ad, aj, or ay (e.g., Wi-Fi 6® or WiGig®); an IEEE 802.16 standard (e.g., WiMAX®); a Bluetooth Classic® standard; a Bluetooth Low Energy® or BLE® standard; an IEEE 802.15.4 standard (e.g., Thread® or ZigBee®); other protocols and/or standards that may be established and/or maintained by various governmental, industry, and/or academia consortiums, organizations, and/or agencies; and so forth. Therefore, the network 116 may be a cellular network, the Internet, a wide area network (WAN), a local area network (LAN), a wireless LAN (WLAN), a wireless personal-area-network (WPAN), a mesh network, a wireless wide area network (WWAN), a peer-to-peer (P2P) network, and/or a Global Navigation Satellite System (GNSS) (e.g., Global Positioning System (GPS), Galileo, Quasi-Zenith Satellite System (QZSS), BeiDou, GLObal NAvigation Satellite System (GLONASS), Indian Regional Navigation Satellite System (IRNSS), and so forth).

In addition to, or alternatively of, the communications illustrated in FIG. 1, the environment 100 may facilitate other unidirectional, bidirectional, wired, wireless, direct, and/or indirect communications utilizing one or more communication protocols and/or standards. Therefore, FIG. 1 does not necessarily illustrate all of the communication signals utilized in this disclosure.

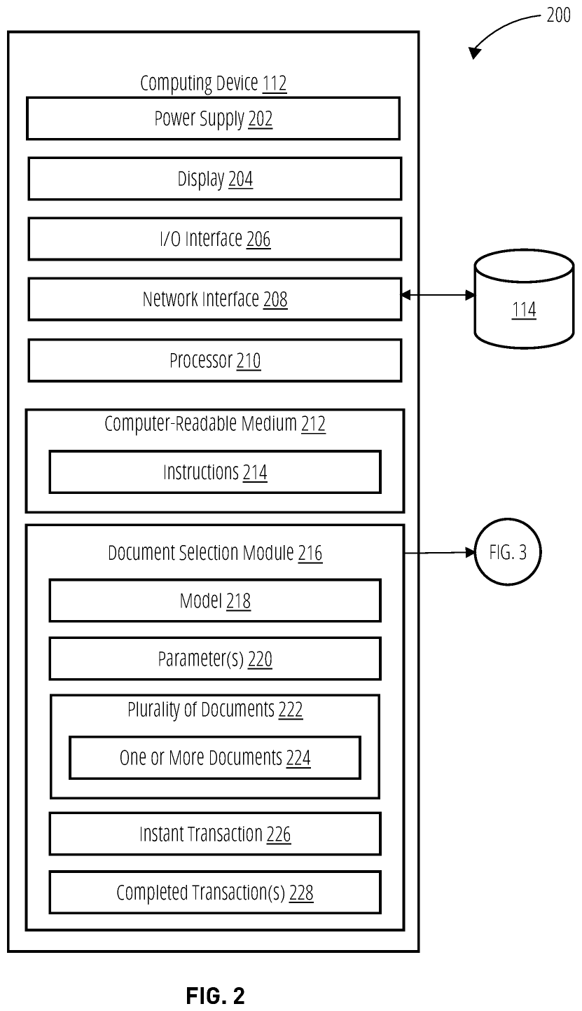

FIG. 2 illustrates an environment 200 of an example computing device 112 accessing data of one or more completed transaction(s) 228 that may be stored in the database(s) 114 in accordance with examples described herein. For clarity, FIG. 2 is partly described in the context of FIG. 1. In FIG. 2, the example computing device is illustrated as the computing device 112 of FIG. 1. Nevertheless, for the sake of brevity, the description(s) of the computing device 112 of FIGS. 1 and 2 may also be applicable to the user device 104 of FIG. 1 or any other user device and/or computing device that may not be explicitly illustrated in FIGS. 1 and 2.

In some embodiments, the computing device 112 may include a power supply 202, a display 204, an input/output (I/O) interface 206, a network interface 208, at least one processor 210 (processor 210), and at least one computer-readable medium 212 that include(s) instructions 214.

In some embodiments, the power supply 202 may provide power to various components within the computing device 112. Further, the power supply 202 may include one or more rechargeable, disposable, or hardwire sources, for example, a battery(ies), a power cord(s), an alternating current (AC) to direct current (DC) inverter (AC-to-DC inverter), a DC-to-DC converter, and/or the like. Additionally, the power supply 202 may include one or more types of connectors or components that provide different types of power (e.g., AC power, DC power) to any device that may be connected to the computing device 112. Additionally, or alternatively, the connector of the power supply 202 may also transmit data to and from any device connected to the computing device 112. For example, the connector of the power supply 202 may facilitate transmission of data to the database(s) 114, the user device 104 of the user 102, the printer 110, the network 116, and/or any other device that may be capable of receiving and/or transmitting data.

In some embodiments, the display 204 may be optional in the computing device 112 and may only be included in the user device 104 and/or any other device that may communicate with the computing device 112. However, if the computing device 112 (and/or the user device 104) includes and/or utilizes a display 204, the display 204 may display visual information, such as an image(s), a video(s), a graphical user interface (GUI), notifications, and so forth to a user (e.g., user 102). The display 204 may utilize a variety of display technologies, such as a liquid-crystal display (LCD) technology, a light-emitting diode (LED) backlit LCD technology, a thin-film transistor (TFT) LCD technology, an LED display technology, an organic LED (OLED) display technology, an active-matrix OLED (AMOLED) display technology, a super AMOLED display technology, and so forth. Furthermore, the display 204 may be a touchscreen display that may utilize any type of touchscreen technology, such as a resistive touchscreen, a surface capacitive touchscreen, a projected capacitive touchscreen, a surface acoustic wave (SAW) touchscreen, an infrared (IR) touchscreen, and so forth. In such a case, the touchscreen may allow the user device 104 to interact with the computing device 112 of FIGS. 1 and 2. For example, using a GUI displayed on the display 204 (e.g., of computing device 112 and/or user device 104), the user 102 may enter one or more parameters associated with an instant transaction; select a desired confidence threshold of the one or more documents of the plurality of documents to complete the instant transaction; determine a past time period to view completed transactions; selectively accept or reject each document of the one or more documents of the plurality of documents to complete the instant transaction; select one or more documents and create a group of the selected documents to be used in a future transaction; and/or so forth.

In some embodiments, the I/O interface 206 of the computing device 112 may enable the computing device 112 to receive an input(s) from the user 102 of FIG. 1 and provide an output(s) to the user 102, for example, via the user device 104. In some embodiments, the I/O interface 206 may include, may be integrated with, and/or may operate in concert and/or in situ with another component of any of the computing device 112, the user device 104, the database(s) 114, the network 116, the base station(s) 118, the satellite(s) 120, and/or so forth.

In some embodiments, the network interface 208 illustrated in FIG. 2 may enable the computing device 112 to receive and/or transmit data directly to any of the network interfaces of any device or component illustrated and/or described in FIG. 1 and/or any other figure in this disclosure. Alternatively, or additionally, the computing device 112 may utilize the network interface 208 to communicate with other devices indirectly by, for example, using the network 116 of FIG. 1. Additionally, or alternatively, the network interface 208 illustrated in FIG. 2 may include and/or utilize an application programming interface (API) that may interface with and/or translate requests across the network 116 of FIG. 1, and the network interface 208 may support a wired and/or a wireless communication using any of the aforementioned communication protocols and/or standards.

In some embodiments, the processor 210 illustrated in FIG. 2 may be substantially any electronic device that may be capable of processing, receiving, and/or transmitting the instructions 214 that may be included in, permanently or temporarily saved on, and/or accessed by the computer-readable medium 212. In some aspects, the processor 210 may be implemented using one or more processors (e.g., a central processing unit (CPU), a graphic processing unit (GPU)), and/or other circuitry, where the other circuitry may include at least one or more of an application specific integrated circuit (ASIC), a field programmable gate array (ASIC), a microprocessor, a microcomputer, and/or the like. Furthermore, the processor 210 may be configured to execute the instructions 214 in parallel, locally, and/or across the network 116 of FIG. 1, for example, by using cloud and/or server computing resources.

In some embodiments, the computer-readable medium 212 illustrated in FIG. 2 may be and/or include any suitable data storage media, such as volatile memory and/or non-volatile memory. Examples of volatile memory may include a random-access memory (RAM), such as a static RAM (SRAM), a dynamic RAM (DRAM), or a combination thereof. Examples of non-volatile memory may include a read-only memory (ROM), a flash memory (e.g., NAND flash memory, NOR flash memory), a magnetic storage medium, an optical medium, a ferroelectric RAM (FeRAM), a resistive RAM (RRAM), and so forth. Moreover, the computer-readable medium 212 does not include transitory propagating signals or carrier waves. Note that the user device 104 may include a computer-readable medium that may be similar to, equivalent to, and/or the same as the computer-readable medium 212 of the computing device 112.

In some embodiments, the instructions 214 may be included in, permanently or temporarily saved on, and/or accessed by the computer-readable medium 212 of FIG. 2. The instructions 214 may include code, pseudo-code, algorithms, models (e.g., machine-learned models), software modules and/or so forth and are executable by the processor 210. Furthermore, the instructions 214 are suitable to be executed using an operating system (OS, not illustrated) of the computing device 112.

In some embodiments, the computing device 112 of FIGS. 1 and 2 and/or the user device 104 of FIG. 1 can utilize the document selection module 216 illustrated in FIG. 2. The document selection module 216 may be a software module and/or may include a software model 218 (model 218). The document selection module 216, the model 218, and the instructions 214 may be fully integrated, partly integrated, or fully separate. Moreover, in some embodiments, the document selection module 216 and/or the model 218 may be integrated with and/or operate in conjunction with another software module that may not be explicitly illustrated and/or described herein (e.g., an existing deal management system).

In some embodiments, any of the instructions 214 of the computer-readable medium 212, the document selection module 216, and/or the model 218 may include disparate code, pseudo-code, algorithms, machine-learned models, software modules, and/or so forth that may be stored in different locations of one or more computer-readable storage media, which together may implement the described functionality of the illustrated module(s) of FIG. 2. Some embodiments may be practiced in a distributed computing environment where tasks are performed by a remote processing device linked through a communications network, such as the network 116. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database (e.g., the database(s) 114) across a network (e.g., the network 116).

In some embodiments, the document selection module 216 may aid the user 102 in finding and selecting the documents (e.g., one or more documents 106 of FIG. 1) that may be required to complete a transaction (e.g., an instant transaction). To do so, the user 102 may utilize a GUI associated with, or included in, the instructions 214, the document selection module 216, and/or the model 218 of FIG. 2.

In some embodiments, the document selection module 216 may access (e.g., from the database(s) 114) and/or include the parameter(s) 220. In some aspects, one parameter, some parameters, or all of the parameter(s) 220 may include a binary value(s), such as a “zero (0)” or a “one (1),” a “yes” or a “no,” an “include” or a “does not include,” a “have” or a “does not have,” a “low” or a “high,” an “above a threshold limit” or a “below the threshold limit,” and/or other binary values. In other aspects, one parameter, some of the parameters, or all of the parameter(s) 220 may include one value that may be set by the establishment (e.g., the car dealership). In other aspects, one parameter, some of the parameters, or all of the parameter(s) 220 may include a value of zero (0), a value that is greater or less than zero (0), a real number, an imaginary number (e.g., √(−1)=i or =j), a rational number (e.g., 10.5), an irrational number (e.g., π, e), a combination thereof, and/or so forth. In yet other aspects, one parameter, some parameters, or all of the parameter(s) 220 may include a word, a phrase, a descriptive letter, a characterizing integer, or a combination thereof.

In some embodiments, the document selection module 216 of FIG. 2 may access, list, and/or select one or more documents 224 of FIG. 2 from a plurality of documents 222 of FIG. 2 in order for the user 102 of FIG. 1 to complete a transaction, such as an instant transaction 226 of FIG. 2. For example, the document selection module 216 of FIG. 2 may initially list the one or more documents 224 of FIG. 2. Then, the user 102 of FIG. 1 may review the listed documents (e.g., the one or more documents 224). After reviewing the listed documents, the user 102 may accept and/or select one, some, or all of the listed documents to complete the instant transaction. Alternatively, the user 102 may reject all of the listed documents. Generally, the user 102 can selectively accept or reject each document of the list of documents (e.g., the one or more documents 224). Note that the one or more documents 224 illustrated in FIG. 2 may be the same as, similar to, and/or equivalent to the one or more documents 106 of FIG. 1. As is illustrated in FIG. 2, a count of one or more documents 224 needed to complete the instant transaction 226 is less than, or equal to, a count of the plurality of documents 222. At least theoretically, the plurality of documents 222 may include documents used in a majority of, most of, or all of the transactions associated with the establishment (e.g., the car dealership). Furthermore, each document (or some of the documents) of the plurality of documents 222 may include more than one version of said document. Therefore, it is to be appreciated that the instructions 214, the document selection module 216, the model 218, or a combination thereof enable the user 102 to correlate the parameter(s) 220; the completed transaction(s) 228 over a past time period; the one or more documents 224; the plurality of documents 222; and/or each version of the plurality of documents 222 to complete the instant transaction 226. Furthermore, after the user 102 completes the instant transaction 226, the methods, user devices, computing devices, and/or systems described herein can store the instant transaction 226 and the parameters (e.g., particular values of the parameter(s) 220) associated with the instant transaction 226 to, for example, the database(s) 114. By so doing, the instant transaction 226 increases an accuracy of the methods, the document selection module 216, the user devices (e.g., the user device 104), the computing devices (e.g., the computing device 112), and/or the systems (e.g., environment 100, environment 200) described herein to automatically list (e.g., for the user 102 to select) another one or more documents to complete a future transaction in a future time period.

In some embodiments, the document selection module 216 of FIG. 2 may access (e.g., from the database(s) 114) and/or include the completed transaction(s) 228, where the completed transaction(s) 228 may be completed during a past time period from the user 102 and/or another user that may be working in, or may be associated with, the same establishment (e.g., the car dealership) as the user 102. Each completed transaction of the completed transaction(s) 228 may include the one or more documents (e.g., the one or more documents 106 of FIG. 1, the one or more documents 224 of FIG. 2), the parameters (e.g., particular values of the parameter(s) 220), and/or the versions associated with each completed transaction.

In some embodiments, however, a count of the completed transaction(s) 226 may be zero, one, two, or a considerably low count (e.g., less than 10, less than 20). For example, a car dealership may be a new car dealership and may not have any available historical data. As another example, a car dealership may have recently purchased and/or adopted the methods and/or systems described herein. It is to be appreciated that in either case, the car dealership may still utilize the document selection module 216 to complete the instant transaction 226, without a prior set up of the document selection module 216. For example, the car dealership may initially encourage the more senior or experienced salespersons to complete the first few transactions. In such a case, after the experienced salespersons complete some transactions, the document selection module 216 enables other salespersons to leverage the documents used by the more experienced salespersons to complete the transactions. Therefore, in some embodiments, the document selection module 216 may be tailored to a specific car dealership.

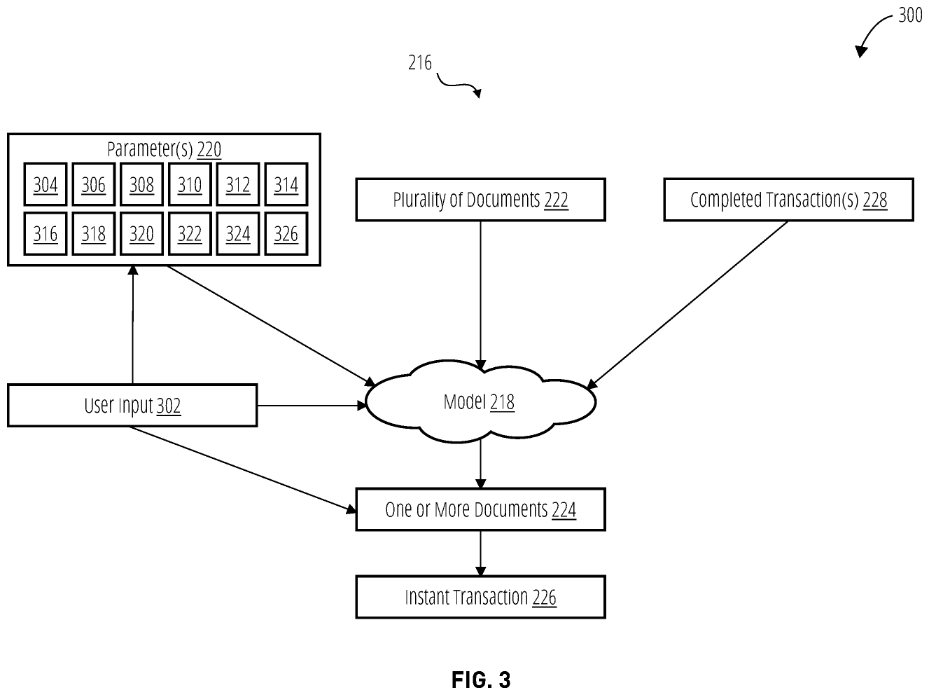

FIG. 3 illustrates an environment 300 of the document selection module 216 of FIGS. 2 and 3 in accordance with examples described herein. FIG. 3 is described in the context of FIGS. 1 and 2. For the sake of brevity, FIG. 3 focuses on the establishment being a car dealership. Nevertheless, the methods and systems described herein may be used by establishments other than car dealerships.

As described herein, the document selection module 216 includes and/or utilizes the model 218 of FIGS. 2 and 3. Inputs to the model 218 may include the parameter(s) 220 illustrated in FIGS. 2 and 3, the plurality of documents 222 illustrated in FIGS. 2 and 3, the completed transaction(s) 228 illustrated in FIGS. 1 and 2, and user input 302 (e.g., from the user 102 of FIG. 1). At least one output of the model 218 includes one or more documents 224 illustrated in FIGS. 2 and 3 and/or one or more documents 106 illustrated in FIG. 1. As is described and illustrated herein, the one or more documents 224 is (are) a subset of the plurality of documents 222. Furthermore, the one or more documents 224 may enable a user to complete an instant transaction 226 illustrated in FIGS. 2 and 3. The instant transaction 226 may be a financial transaction between a plurality of parties, for example, between the user 102 of FIG. 1 and the person 108 of FIG. 1. Note that, as is illustrated in FIG. 3, the user input 302 may include input from the user 102 to the parameter(s) 220, the model 218, and/or the one or more documents 224, as is further described herein.

In some embodiments, the model 218 may be and/or may include code, pseudo-code, an algorithm(s), a machine-learned model(s), and the like to analyze inputs to the model 218. Based on the analysis(es) of the inputs, the model 218 may automatically list documents (e.g., one or more documents 106 of FIG. 1, one or more documents 224 of FIGS. 2 and 3) that may be required to complete the instant transaction 226.

As the user 102 and/or other users working in the car dealership may utilize the user device 104, the computing device 112, another user device that may not be explicitly illustrated, the code, the pseudo-code, and/or the algorithm of the document selection module 216 and/or the model 218 and may store the parameters (e.g., parameter(s) 220) and forms (e.g., one or more documents 224) associated with a given deal and/or transaction. In some embodiments, the deal and/or the transaction may include selling, buying, trading in, and/or repairing one or more vehicles. For example, the code, the pseudo-code, and/or the algorithm of the document selection module 216 and/or the model 218 may include and/or utilize a first variable (e.g., a variable called “ID”) to associate each completed deal and/or transaction with a unique identification value (e.g., a unique alphanumeric identification). As another example, the code, the pseudo-code, and/or the algorithm of the document selection module 216 and/or the model 218 may include and/or utilize a second variable (e.g., a variable called “storeID”) to associate each completed deal and/or transaction with a car dealership (e.g., a specific car dealership, such as “Jane Doe's Portland Automotive”). As another example, the code, the pseudo-code, and/or the algorithm of the document selection module 216 and/or the model 218 may include and/or utilize a third variable (e.g., a variable called “dealProperties”) to associate the particular parameter values of each completed deal and/or transaction. As yet another example, the code, the pseudo-code, and/or the algorithm of the document selection module 216 and/or the model 218 may include and/or utilize a fourth variable (e.g., a variable called “documents”) to associate an aggregate list of documents (or forms) that may have been used to complete each deal and/or transaction (e.g., completed transaction(s) 228 of FIGS. 2 and 3). Note that a count of the aggregate list of documents (e.g., a count of the one or more documents 224, a count of the one or more documents 106) used for each completed deal and/or transaction is less than (or considerably less than) a count of the total available documents (e.g., a count of the plurality of documents 222).

Consequently, in some embodiments, the document selection module 216 and/or the model 218 may leverage “lessons learned” from completed deals and/or transactions (e.g., completed transaction(s) 228) to complete the next deal(s) and/or transaction(s) (e.g., instant transaction 226). For example, during successful previous sales (e.g., sales that do not need a “rewrite”), a first salesperson(s) may have used one or more documents (e.g., one or more documents 224) of the available documents (e.g., plurality of documents 222) to complete a transaction. The document selection module 216 and/or the model 218 described herein may then enable a second salesperson(s) to retrieve (e.g., from the database(s) 114) the one or more documents 224 for the next deal and/or transaction (e.g., instant transaction 226). Note that the first salesperson may be the same as, or different from, the second salesperson.

In some embodiments, the document selection module 216 and/or the model 218 may utilize an application programming interface (API) that may enable the document selection module 216 and/or the model 218 to associate, transmit, receive, store, and/or utilize the parameter(s) 220, the plurality of documents 222, the completed transaction(s) 228, and the user input 302, while utilizing the user device 104, the computing device 112, the database(s) 114, or a combination thereof.

In some embodiments, when the user 102 selects one or more documents with the intention of completing an instant transaction (e.g., the instant transaction 226), the computing device 112 utilizes the API of the document selection module 216 and/or model 218. The API may include names, labels, and/or qualifiers of each of the one or more documents and the values of each of the parameter(s) 220, including the variable called “dealProperties.” The API may include the selected one or more documents to a record associated with the instant transaction, and the API sets the value of the variable “dealProperties” of the instant transaction. In some embodiments, the list of the one or more documents may be a cumulative list, however, the value of the “dealParameters” may be and/or may include the most recent values. For example, if the user 102 prints two sets of one or more documents for a given instant transaction, the database(s) 114 may ultimately include a record for the instant application that associates the variable called “ID” with a cumulative list of one or more documents that includes a union of both sets of printed one or more documents and a value for “dealParameters” that matches the “dealParameters” of the second (e.g., the most recent) print attempt.

To illustrate another embodiment of the training of the model 218, consider these three example transactions using a previously untrained model 218. For a first example transaction, when using the untrained model 218, a first user may elect not to select any documents (e.g., zero documents) when completing a first deal. In this first example transaction, the API of the document selection module 216 and/or the model 218 may associate and may record (e.g., a first completed transaction(s) 228 in the database(s) 114) the first deal with no specific documents. For a second example transaction, however, a second user (or the first user using utilizing the document selection module 216 and/or the 218 for the second time) may select some documents (e.g., one or more documents 224) of the total documents (e.g., the plurality of documents 222), when completing a second deal, where the values of the of the parameter(s) 220 of the second deal may be the same as the values of the parameter(s) 220 of the first deal. In this second example transaction, the API of the document selection module 216 and/or the model 218 may associate and may record the second deal with the one or more documents 224. For a third example transaction, the first, the second, or a third user may use an auto suggest document selection feature (auto suggest) of the document selection module 216 and/or the model 218, when completing a third deal, where the values of the parameter(s) 220 of the third deal may be the same as values of the parameter(s) 220 of the first and the second deals. In this third example transaction, the API of the document selection module 216 and/or the models 218 may suggest (auto suggest) the one or more documents 224 with a 50% confidence as being the correct documents to the complete the third deal (e.g., the instant transaction 226). It is to be understood that the document selection module 216 and/or the model 218 tracks, monitors, and/or suggests a specific confidence level (e.g., in a percentage) for each document of the one or more documents 224 when completing the instant transaction 226.

In an example embodiment, the user 102 of FIG. 1 may utilize a display of the user device 104 of FIG. 1 and may interact with a GUI to enter and/or select values of the parameter(s) 224 that represent and/or associated are with an instant transaction (e.g., a deal). Using the GUI, the user 102 may then request a list of one or more documents (e.g., the one or more documents 224) needed to complete the instant transaction. The user 102 may also select a desired confidence threshold (e.g., 90%, etc.) that the requested list of documents are the required documents to complete the instant transaction. For brevity and clarity in describing the example embodiment, the user 102 may set one value (e.g., a state) of one parameter (e.g., a buyer residence jurisdiction parameter) of the parameter(s) 224 to, for example, the buyer's residence being Oregon (“OR”). Continuing with the example embodiment, after the user 102 requests the list of the one or more documents and the desired confidence threshold to complete the instant transaction, the systems and methods described herein may complete some example steps based on the user 102's input. An example step(s) may include a user interface of the computing device 112 submitting a request to the API of the document selection module 216 and/or the model 218 for a list of suggested forms (e.g., one or more documents 224) by providing the values of each of the parameter(s) 224 that represent and/or are associated with the instant transaction. Another example step may include the computing device 112 accessing the database(s) 114, where the database(s) 114 may associate each transaction (or deal) to a set of deal parameters, including a list of documents associated with completed transactions that may be similar, equivalent, and/or the same as the instant transaction. Another example step of the example embodiment (e.g., the buyer's residence being Oregon) may include the computing device 112 utilizing the API of the document selection module 216 and/or model 218 to filter the completed transactions to filtered transactions and the associated documents of the filtered transactions that include the buyer's residence being Oregon. Another example step of the example embodiment may include the API of the document selection module 216 and/or model 218 evaluating the filtered transactions of the completed transactions to determine the list of documents that have been used in the filtered transactions, and the list of documents meet or exceed the desired confidence threshold. As such, if the desired confidence threshold is 90%, then, the determined each document of the list of documents has been used in at least 90% of the cases of the filtered transactions. The API of the document selection module 216 and/or model 218 may perform similar aforementioned example steps for each parameter of the parameter(s) 220. It is to be appreciated that the API of the document selection module 216 and/or model 218 may evaluate each parameter of the plurality of parameter(s) 220, independently. The final list of the documents (e.g., the one or more documents 224) may be a mathematical union of documents that are listed based on the independent evaluation(s) of each parameter of the of parameter(s) 220.

In some embodiments, the API (not illustrated) of the document selection module 216 and/or the model 218 may analyze each value (or attribute) of each of the parameter(s) 220, the plurality of documents 222, the completed transaction(s) 228, and/or the user input 302 and their relationship to each other, which may be stored in the database(s) 114. As a user (e.g., the user 102) utilizes the document selection module 216 and/or the model 218 to complete an instant transaction 226, the API aids the user device 104 and/or the computing device 112 to access the data stored in database(s) 114. The API then may aid the document selection module 216 and/or the model 218 to return and rank each of the one or more documents 224 based on a confidence level that each of the one or more documents 224 may be required to complete the instant transaction 226.

Additionally, or alternatively, the model 218 may be a machine-learned model, such as a neural network, a support vector machine, a recurrent neural network (RNN), a convolutional neural network (CNN), a dense neural network (DNN), heuristics, or a combination thereof. For clarity, inputs to the machine-learned model may be the parameter(s) 220, the plurality of documents 222, the completed transaction(s) 228, and/or user input 302. Outputs of the machine-learned model may be the one or more documents 224 and/or the instant transaction 226. In the case of the machine-learned model, the user input 302 to the one or more documents 224 may help speed up and/or increase the accuracy of the model training. For example, referring to FIG. 3, the user 102 may select other documents in addition to the one or more documents 224 selected by the model 218; the user 102 may make no changes to the one or more documents 224 selected by the model 218; the user 102 may unselect some of the one or more documents 224 selected by the model 218; or a combination thereof.

In some embodiments, the user 102 may communicate with the person 108 to understand and/or evaluate the type of the deal involving, for example, selling, buying, trading in, and/or repairing one or more vehicles. Consequently, the user input 302 may define the values of the parameter(s) 220. FIG. 3 illustrates example parameters, and the parameter(s) 220 may include fewer parameters, a larger count of parameters, different parameters, or a combination thereof. In some embodiments, the parameter(s) 220 may include a deal type parameter 304 (deal type 304); a financial institution parameter 306 (financial institution 306); a stock type parameter 308 (stock type 308); a buyer type parameter 310 (buyer type 310); a co-buyer status parameter 312 (co-buyer status 312); a first trade-in status parameter 314 of a first vehicle (first trade-in status 314); a second trade-in status parameter 316 of a second vehicle (second trade-in status 316); a first loan status parameter 318 of the first vehicle (first loan status 318); a second loan status parameter 320 of the second vehicle (second loan status 320); a mechanical breakdown insurance (MBI) status parameter 322 (MBI status 322); a buyer residence jurisdiction parameter 324 (buyer jurisdiction 324); a vehicle (or car) dealership jurisdiction parameter 326 (vehicle dealership jurisdiction 326); or other parameters that may not be explicitly illustrated or described herein.

Some of the parameters of the parameter(s) 220 may include a binary value(s), such as a “zero (0)” or a “one (1)”; a “yes” or a “no”; an “include” or a “does not include”; a “have” or a “does not have”; and/or other binary values. For example, the co-buyer status 312 may include (or be) “has a co-buyer” when the buyer has a co-buyer, or the co-buyer status 312 may include (or be) “does not have a co-buyer” when the buyer does not have a co-buyer. As another example, the first trade-in status 314 may include “has a first trade-in” when the buyer may be trading in a vehicle, or the first trade-in status 314 may include “does not have a first trade-in” when the buyer may not be trading in a vehicle. As yet another example, the second trade-in status 316 may include “has a second trade-in” when the buyer may be trading in a first and a second vehicle, or the second trade-in status 316 may be “does not have a second trade-in” when the buyer is not trading in a second vehicle.

In some embodiments, one parameter value of the parameter(s) 220 may affect another parameter value of the parameter(s) 220. For example, assume the person 108 desires to purchase a new vehicle, and assume the person 108 is not trading in any vehicles. In such a case, the user 102 may select the first trade-in status 314 to be “does not have a first trade-in.” Consequently, the document selection module 216 may automatically set the second trade-in status 316 to be “does not have a second trade-in,” the first loan status 318 to be “does not have an unpaid first loan for the first vehicle,” and/or the second loan status 320 to be “does not have an unpaid second loan for the second vehicle.”

In some embodiments, some of the parameters may include more than two values. For example, the deal type 304 may include “selling,” “trading in,” “buying,” “leasing,” “repairing,” or a combination thereof. As another example, the buyer jurisdiction 324 may include a state, a city, a county, a zone improvement plan (ZIP) code, or a combination thereof of the buyer, and the buyer jurisdiction 324 may be the same or may differ from the vehicle dealership jurisdiction 326. Depending on the buyer jurisdiction 324, the user 102 may select specific documents that may be required to meet the legal requirements of the buyer jurisdiction 324. For example, certain DMVs in certain states may have different requirements to register and/or operate a vehicle. As another example, even in a same state, certain counties or cities may have stricter (or different) vehicle emission requirements. In such a case, the user 102 may need to select a document that certifies that the vehicle being sold to the person 108 meets the buyer jurisdiction 324's requirements, even when the buyer jurisdiction 324 requirements may differ from the vehicle dealership jurisdiction 326 requirements. As yet another example, the car dealership, the user 102, and/or the person 108 may use one of several financial institutions (e.g., banks) to finance the purchase of a vehicle.

Although, generally, each parameter of the parameter(s) 220 may include a value (e.g., the State of Oregon) of a plurality of values (e.g., two or more values, 50 states of the United States of America plus each of her territories), the document selection module 216 may enable the user 102 to preset a parameter to a single value. For instance, the vehicle dealership jurisdiction 326 may be set the first time the user 102 or any other employee of the car dealership utilizes the document selection module 216 and/or the model 218. In such a case, since not all states of the United States of America use (or have) a sales tax, depending on the vehicle dealership jurisdiction 326, the transactions (e.g., instant transaction 226) may or may not include a state sales tax. As another example, each state may have different regulations regarding transactions using a digital or virtual currency (e.g., cryptocurrency).

In some embodiments, regardless of the values of each of the parameter(s) 220, each deal and/or transaction may include one or more documents that a manager and/or an owner of a car dealership may use in each transaction. For example, Jane of “Jane Doe's Portland Automotive” may instruct her employees to donate a portion of each sale to a cause Jane cares about, and Jane may want to include a document stating the amount of funds that were donated after the transaction is completed. Jane may do so for the sake of transparency, for legal reasons, for name recognition, for building a relationship with the community around “Jane Doe's Portland Automotive,” or other reasons.

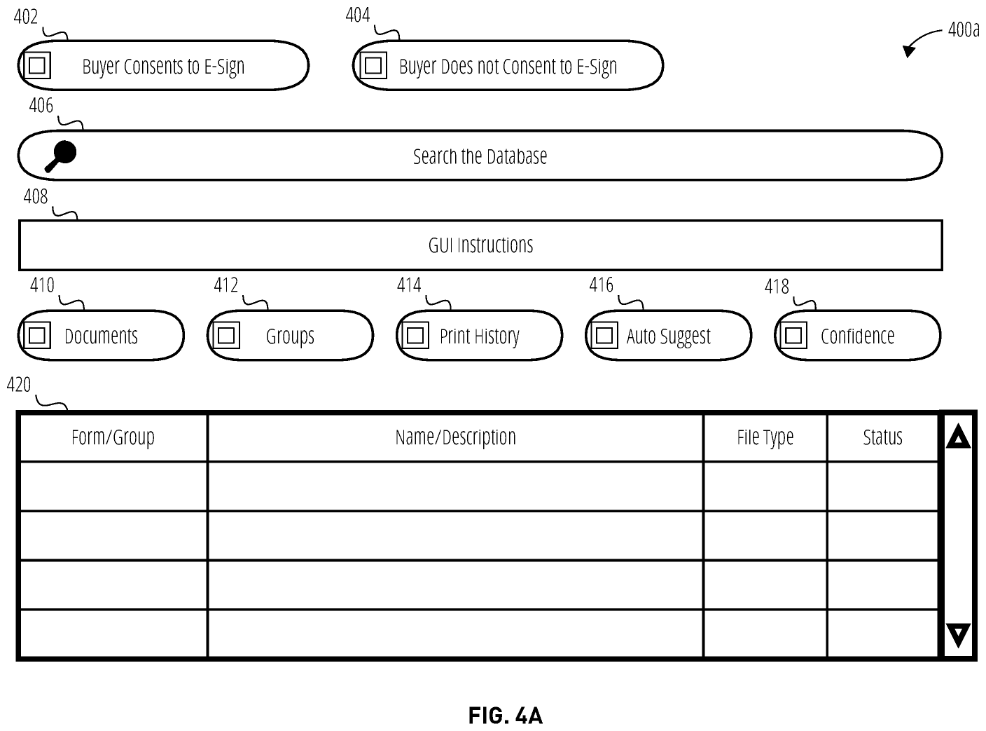

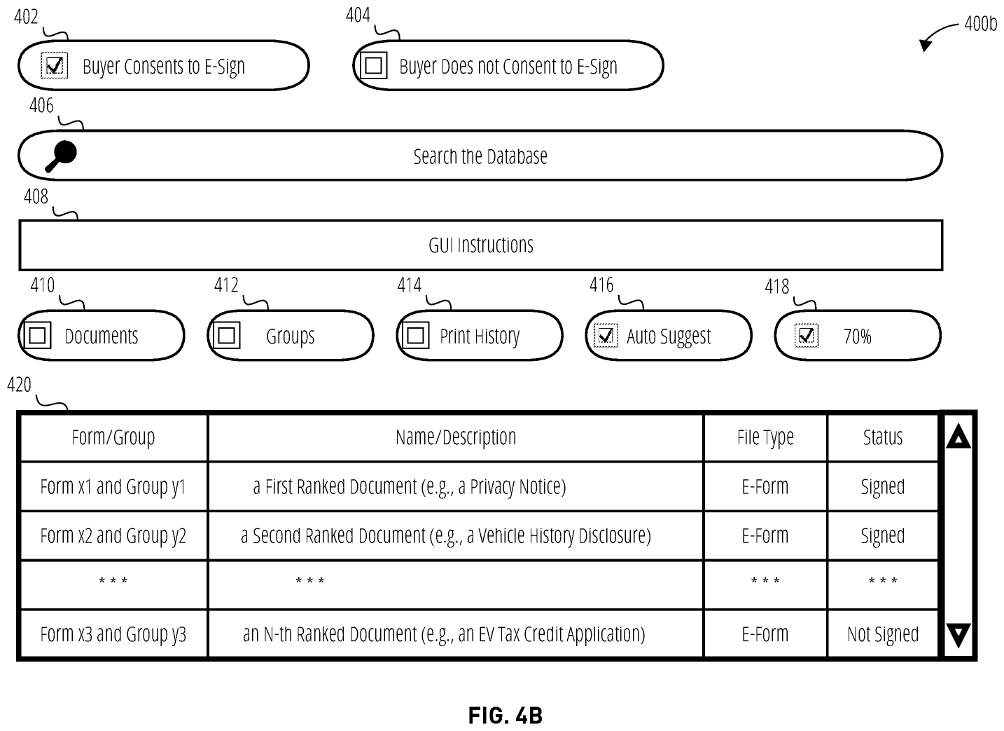

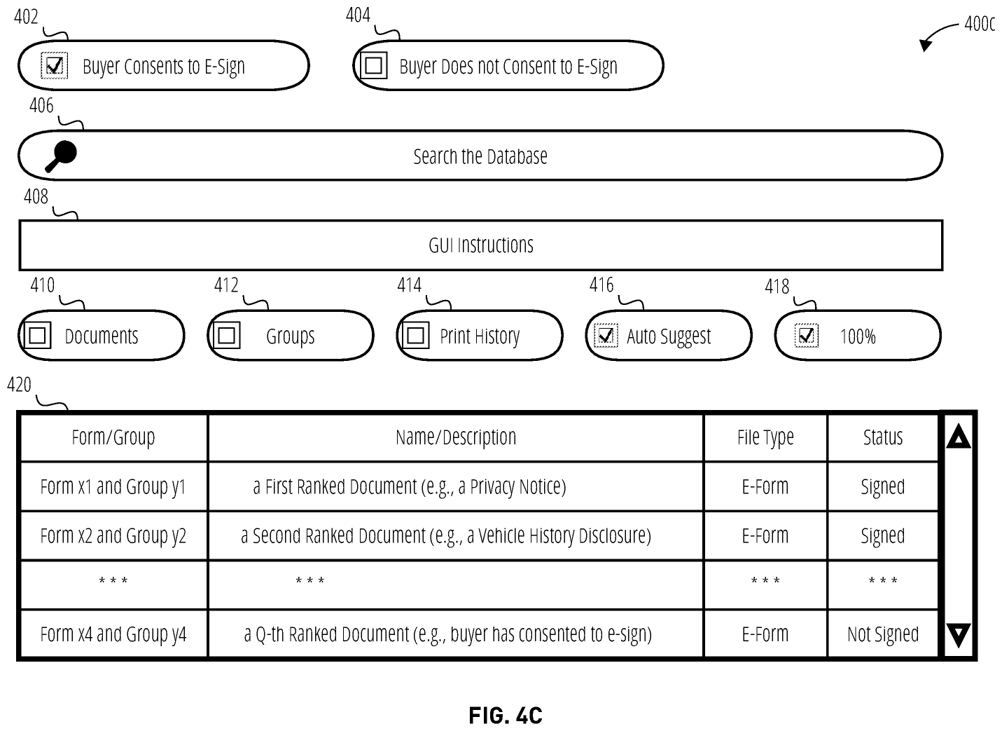

FIGS. 4A, 4B, and 4C are example illustrations 400a, 400b, and 400c, respectively, of an example graphic user interface (GUI), and the GUI may aid a user in selecting one or more documents of a plurality of documents to complete an instant transaction in accordance with examples described herein. The GUI(s) may differ without limiting the scope of the methods and systems described herein. Furthermore, the user device 104 and/or the computing device 112 may utilize other features, such as a voice assistant application software that may enable the user (e.g., the user 102 of FIG. 1) to utilize the methods and systems described herein without relying on the illustrated GUI(s).

In some embodiments, FIG. 4A may illustrate the GUI in a state when the user 102 has not made any selections (e.g., with no user input 302). For example, the GUI of FIG. 4A may represent what the user 102 may see when opening an application software (not illustrated) that uses the document selection module 216 and/or the model 218 to complete an instant transaction (e.g., instant transaction 226).

In FIGS. 4A, 4B, and 4C, the GUI may include a first example button that the user 102 may select (e.g., check or press) when the person 108 consents to signing electronically the required documents (e.g., one or more documents 224) to complete an instant transaction. In FIGS. 4A, 4B, and 4C, the first example button is illustrated and/or may be described as a “buyer consents to e-sign 402” button. Alternatively, if the person 108 does not consent to signing electronically the required documents, the user 102 may select a second example button, where the second button is illustrated and/or may be described as a “buyer does not consent to e-sign 404” button. In the case that the user 102 selects the buyer does not consent to e-sign 404 button, the user 102 may use the printer 110 of FIG. 1 to print the required documents (e.g., one or more documents 224 of FIGS. 2 and 3, one or more documents 106 of FIG. 1) to complete the instant transaction 226.

In some embodiments, the GUI may also include a search field for searching the database (e.g., the database(s) 114). In FIGS. 4A, 4B, and 4C, the search field for searching the database is illustrated and/or may be described as “search the database 406.” In some embodiments, using the search the database 406, the user 102 may search the database for any document of the plurality of documents 222, for example, by using a keyword, a code, a phrase, or a combination thereof that may describe the document. Alternatively, or additionally, the user 102 may use the search the database 406 to search the database for any of the completed transaction(s) 228, any previous user activity (e.g., any user working in the car dealership), any value of any of the parameter(s) 220, and/or so forth.

In some embodiments, the GUI may also include and/or display instructions to the user 102. For example, using a toast, a dialog box, and the like, the instructions to the user 102 may be illustrated and/or may be described as “GUI instructions 408.” The GUI instructions 408 may be static, dynamic, or a combination thereof. Examples of the GUI instructions 408 may include phrases such as “select the document(s) you want to print or transmit”; “one or more of the selected document(s) need a buyer's signature”; “the instant transaction is successfully completed”; “the selected document(s) has (have) a lower confidence threshold than the pre-determined confidence threshold”; “the selected document(s) has (have) a confidence threshold that meets or exceeds the pre-determined confidence threshold”; and/or other instructions that may aid the user 102 in successfully completing the instant transaction 226 and/or reduce the time period it takes to complete the instant transaction 226 compared to using conventional solutions.

In some embodiments, the GUI may also include and/or display a third example button that the user 102 may choose to select when searching for documents, for example, by using the search the database 406. In FIGS. 4A, 4B, and 4C, the third example button is illustrated and/or may be described as a “documents 410” button. For example, the user 102 may be working on a new type of deal, and the user 102 may want to complete the new deal by searching the database(s) 114 for each of the one or more documents 224 required to complete the instant transaction 226. The user 102 may elect to use the documents 410 for cases when the document selection module 216 and/or the model 218 may be previously untrained. Alternatively, the user 102 may select the documents 410 button to add additional documents than what the document selection module 216 and/or the model 218 may automatically suggest.

In some embodiments, the GUI may also include and/or display a fourth example button that the user 102 may choose to select to access one or more pre-defined groups of documents. In FIGS. 4A, 4B, and 4C, the fourth example button is illustrated and/or may be described as a “groups 412” button. Some current solution may allow grouping of documents, but these solutions may lack the capability of offering the user 102 a confidence in the selected forms. To take advantage of the current solutions, but still take advantage of the described methods and systems, the GUI(s) of FIGS. 4A, 4B, and 4C show that the user 102 may seemingly switch from using the current solutions (e.g., using pre-defined groups of documents) to using the methods and systems described herein. Using pre-defined groups of documents (e.g., the user 102 selecting the groups 412 button) may require that the user 102 (or another user) maintains these pre-defined groups of documents and have a specific pre-defined group of documents for each combination of inputs to the document selection module 216 and/or the model 218. Since a combination of the values of the parameter(s) 220 may generate many groups of documents that may need to be updated periodically, one motivation of using the document selection module 216 and/or the model 218 is to avoid relying on this considerable setup task. Nevertheless, even when the user 102 elects to use a pre-defined group of documents to complete an instant transaction (e.g., instant transaction 226), the document selection module 216 and/or the model 218 can still provide a percent confidence of each document of the pre-defined group of documents being the correct document for the instant transaction. Additionally, or alternatively, the plurality of documents 222 and/or the model 218 enable the GUI to display the pre-defined group of documents from the highest percent confidence (e.g., 100%) to the lowest percent confidence. Therefore, the GUI described herein can aid the user 102 in understanding the confidence that a selected document is required to complete an instant transaction.

In a preferred embodiment, the GUI may also include and/or display a fifth example button that the user 102 may choose to select to instruct the user device 104 and/or the computing device 112 to utilize the document selection module 216 and/or the model 218 to make an automatic suggestion of the one or more documents 224 needed to complete the instant transaction 226. In FIGS. 4A, 4B, and 4C, this fifth example button of the GUI is illustrated and/or may be described as an “auto suggest 416” button. When the user 102 selects the auto suggest 416 button, the user 102 is at least initially relying on a previously trained model 218 to automatically suggest the one or more documents 224 based on the parameter(s) 220 (and the user input 302 to the parameter(s) 220), the plurality of documents 222, the completed transaction(s) 228, or a combination thereof

In some embodiments, the GUI may also include and/or display a sixth example button that the user 102 may choose to select to instruct the user device 104 and/or the computing device 112 to view a history of printed or transmitted documents during a past time period. In FIGS. 4A, 4B, and 4C, this sixth example button of the GUI is illustrated and/or may be described as a “print history 414” button.

In some embodiments, the GUI may also include and/or display a seventh example button, a box, or a drop-down list that the user 102 may utilize to select a desired confidence threshold (e.g., 0% to 100%, or 0 to 1) of the one or more documents 224 to complete the instant transaction 226. In FIGS. 4A, 4B, and 4C, this seventh example button of the GUI is illustrated and/or may be described as a “confidence 418” button, box, or drop-down list. In a case of a box, a confidence 418 box may allow the user 102 to manually enter a desired confidence threshold by, for example, entering a number between zero and one (e.g., a confidence value from 0% confidence to 100% confidence). In a case of a drop-down list, the user 102 may use the confidence 418 drop-down list to select a pre-determined confidence value, such as a 0%, 10%, 20%, 30%, 40%, 50%, 60%, 70%, 80%, 90%, or 100% confidence. For clarity, 0% confidence may represent a list of the plurality of documents 222 (all documents). In a 0% confidence scenario, the user 102 may not rely on the document selection module 216 and/or the model 218 to help select the one or more documents 224 to complete the instant transaction 226. In a 100% confidence scenario, each of the one or more documents 224 may have been used to complete transactions (e.g., completed transaction(s) 228) that have the same values as the parameter(s) 220 entered by the user 102 to complete the instant transaction 226. Therefore, in the case of a 100% confidence scenario, the document selection module 216 and/or the model 218 relies on data from the completed transaction(s) 228.

In some embodiments, the GUI may also include a file directory 420 that may display a single document accessed from the database(s) 114, the one or more documents 224 accessed from the database(s) 114, other documents accessed from the database(s) 114, a combination thereof accessed from the database(s) 114, or all the documents in the database(s) 114 (e.g., the plurality of documents 222). In some embodiments, each document listed in the file directory 420 may include a form or group qualifier of the document, a name or description of the document, a file type of the document, and a status of the document. Since, for example, in the case of the plurality of documents 222 (e.g., a considerable count of documents), not all the documents may be listed at the same time on a display screen, the GUI of the file directory 420 may also include an up-arrow and a down-arrow to enable the user to scroll up or down to view the results displayed inside the file directory 420.

In FIG. 4A, since the user 102 has not selected any of the buyer consents to e-sign 402 button, the buyer does not consent to e-sign 404 button, the documents 410 button, the groups 412 button, the print history 414 button, the auto suggest 416 button, or the confidence 418 button, box, or drop-down list, the GUI of FIG. 4A does not show any documents inside the file directory 420. Instead, FIGS. 4B and 4C illustrate embodiments of the user 102 making certain selections using the GUI. For the sake of brevity, FIGS. 4B and 4C focus on the auto suggest and the desired confidence threshold features of the described methods and systems. It is to be understood that the GUI allows a myriad of interactions.

In FIG. 4B, the user 102 has selected (illustrated with a check mark) the buyer consents to e-sign 402 button after the person 108 consented to electronically sign the one or more documents 224 required to complete the instant transaction 226. Still in FIG. 4B, the user 102 also has selected the auto suggest 416 button that enables the document selection module 216 and/or the model 218 to auto suggest the one or more documents 224 required to complete the instant transaction 226. Furthermore, still in FIG. 4B, the user 102 has also selected a desired confidence threshold of 70% for each of the one or more documents 224 to meet or exceed to complete the instant transaction 226, for example, given a set of user input 302. Note that prior to requesting making the selections illustrated in FIGS. 4B and 4C, the user 102 may have already entered the values of each of the parameter(s) 220. Also note that due to the limited space, the file directory 420 of FIG. 4B shows only three of N (3 of N) documents, where N is a positive integer. Furthermore, in the file directory 420 the auto suggested documents may be ranked from the highest percent confidence to the lowest percent confidence.

In FIG. 4C, the user 102 has selected a desired confidence threshold of 100%. In such a case, the file directory 420 includes Q documents, where Q is another positive integer. Furthermore, Q (of FIG. 4C) is less than N (of FIG. 4B). Therefore, a higher desired confidence threshold correlates to a lower count of automatically selected documents, and a lower desired confidence threshold correlates to a higher count of the automatically selected documents.

This disclosure includes additional example embodiments of the described methods and systems for selecting one or more documents of a plurality of documents to complete an instant transaction.

### EXAMPLE EMBODIMENTS

Example 1. A computer-implemented method for aiding a user to select one or more documents of a plurality of documents to complete an instant transaction, the computer-implemented method comprising: receiving, from the user, one or more parameters associated with the instant transaction; accessing data of one or more completed transactions over a past time period, each completed transaction of the one or more completed transactions comprises the one or more parameters; based on the one or more parameters received from the user, determining a confidence threshold of each document of the plurality of documents needed to complete the instant transaction; receiving, from the user, a desired confidence threshold of the one or more documents of the plurality of documents to complete the instant transaction; and based on the desired confidence threshold, automatically selecting the one or more documents of the plurality of documents to complete the instant transaction.

Example 2. The computer-implemented method of Example 1, wherein each completed transaction of the one or more completed transactions is stored in a database, and the computer-implemented method uses a pre-determined count of completed transactions of the one or more completed transactions, and wherein the pre-determined count of completed transactions is less than or equal to a total count of the one or more completed transactions.

Example 3. The computer-implemented method of Example 2, wherein the pre-determined count of completed transactions comprises a latter completed transactions of the one or more completed transactions over the past time period.

Example 4. The computer-implemented method of Example 1, wherein the user determines the past time period.

Example 5. The computer-implemented method of Example 1, wherein said receiving, from the user, of the desired confidence threshold comprises the user selecting a pre-determined confidence threshold of a plurality of pre-determined confidence thresholds, and the pre-determined confidence threshold comprises the desired confidence threshold.

Example 6. The computer-implemented method of Example 1, wherein a higher desired confidence threshold correlates to a lower count of the automatically listed one or more documents, and a lower desired confidence threshold correlates to a higher count of the automatically listed one or more documents.

Example 7. The computer-implemented method of Example 1, wherein the instant transaction is associated with a purchasing, a selling, a trading in, a leasing, a repairing, or a combination thereof of one or more vehicles.

Example 8. The computer-implemented method of Example 7, wherein the one or more parameters comprises a transaction type, a financial institution, a stock type, a buyer type, a co-buyer status, a first trade-in status of a first vehicle, a second trade-in status of a second vehicle, a first loan status of the first vehicle, a second loan status of the second vehicle, a mechanical breakdown insurance (MBI) status, a buyer residence jurisdiction, a vehicle dealership jurisdiction, or a combination thereof.

Example 9. The computer-implemented method of Example 1, wherein each parameter of the one or more parameters comprises a plurality of values.

Example 10. The computer-implemented method of Example 1 obviates a need for the user or another user to perform a setup associating the one or more parameters, the plurality of documents, the completed transactions, the instant transaction, or a combination thereof during a current time period, a future time period, the past time period, a time period prior to the past time period, or a combination thereof.

Example 11. A system, the system comprises: a database, the database comprises: one or more parameters; a plurality of documents; and a plurality of completed transactions over the past time period, wherein each of the plurality of completed transactions comprises a first value of each of the one or more parameters and one or more documents of the plurality of documents; a network interface; a processor; and a computer-readable medium storing instructions that, when executed by the processor, configure the system to: accept input from a user, the user input comprises a second value of each of the one or more parameters associated with an instant transaction; access, using the network interface, the plurality of completed transactions from the database; compare the first value to the second value; and based on the comparison, automatically list the one or more documents of the plurality of documents.

Example 12. The system of Example 11, wherein the user utilizes the one or more documents of the plurality of documents to complete the instant transaction.

Example 13. The system of Example 11 further comprises a display screen with a graphic user interface (GUI), and the user utilizes the GUI to selectively accept or reject each listed document of the one or more documents of the plurality of documents.

Example 14. The system of Example 13, wherein the user utilizes the GUI to selectively access each of the plurality of documents.

Example 15. The system of Example 13, wherein the selectively accepted one or more documents of the plurality of documents are used to complete the instant transaction.

Example 16. The system of Example 15, wherein the selectively accepted one or more documents of the plurality of documents, the second value of each of the one or more parameters associated with the instant transaction, and the instant transaction are stored in the database for comparison during a future time period by the user, another user, or a combination thereof.

Example 17. The system of Example 16, wherein the storing in the database increases an accuracy of the system to complete a future transaction in the future time period.

Example 18. The system of Example 15, wherein the instant transaction occurs in a current time period, a future time period, a near future time period, or a combination thereof

Example 19. The system of Example 11, wherein the user input further comprises a desired confidence threshold, the desired confidence threshold being between zero percent confidence and 100 percent confidence.

Example 20. The system of Example 11 being used by a car dealership.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention in this regard; no attempt is made to show structural details of the invention in more detail than is necessary for the fundamental understanding of the invention, the description taken with the drawings and/or examples making apparent to those skilled in the art how the several forms of the invention may be embodied in practice.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

What is claimed is:

1. A computer-implemented method for aiding a user in selecting one or more documents of a plurality of documents to complete an instant transaction, the computer-implemented method comprising:
receiving, from the user, one or more parameters associated with the instant transaction;
accessing data of one or more completed transactions over a past time period, each completed transaction of the one or more completed transactions comprising the one or more parameters;
based on the one or more parameters received from the user, determining a confidence threshold of each document of the plurality of documents needed to complete the instant transaction;
receiving, from the user, a desired confidence threshold of the one or more documents of the plurality of documents to complete the instant transaction; and
based on the desired confidence threshold, automatically listing the one or more documents of the plurality of documents to complete the instant transaction.

2. The computer-implemented method of claim 1, wherein each completed transaction of the one or more completed transactions is stored in a database, and the computer-implemented method uses a pre-determined count of completed transactions of the one or more completed transactions, and wherein the pre-determined count of completed transactions is less than or equal to a total count of the one or more completed transactions.

3. The computer-implemented method of claim 2, wherein the pre-determined count of completed transactions comprises a latter completed transactions of the one or more completed transactions over the past time period.

4. The computer-implemented method of claim 1, wherein the user determines the past time period.

5. The computer-implemented method of claim 1, wherein said receiving, from the user, of the desired confidence threshold comprises the user selecting a pre-determined confidence threshold of a plurality of pre-determined confidence thresholds, and the pre-determined confidence threshold comprises the desired confidence threshold.

6. The computer-implemented method of claim 1, wherein a higher desired confidence threshold correlates to a lower count of the automatically listed one or more documents, and a lower desired confidence threshold correlates to a higher count of the automatically listed one or more documents.

7. The computer-implemented method of claim 1, wherein the instant transaction is associated with a purchasing, a selling, a trading in, a leasing, a repairing, or a combination thereof of one or more vehicles.

8. The computer-implemented method of claim 7, wherein the one or more parameters comprises a transaction type, a financial institution, a stock type, a buyer type, a co-buyer status, a first trade-in status of a first vehicle, a second trade-in status of a second vehicle, a first loan status of the first vehicle, a second loan status of the second vehicle, a mechanical breakdown insurance (MBI) status, a buyer residence jurisdiction, a vehicle dealership jurisdiction, or a combination thereof.

9. The computer-implemented method of claim 1, wherein each parameter of the one or more parameters comprises a plurality of values.

10. The computer-implemented method of claim 1 obviates a need for the user or another user to perform a setup associating the one or more parameters, the plurality of documents, the completed transactions, the instant transaction, or a combination thereof during a current time period, a future time period, the past time period, a time period prior to the past time period, or a combination thereof

11. A system, the system comprises:
a database, the database comprises:
one or more parameters;
a plurality of documents; and
a plurality of completed transactions over the past time period, wherein each of the plurality of completed transactions comprises a first value of each of the one or more parameters and one or more documents of the plurality of documents;
a network interface;
a processor; and
a computer-readable medium storing instructions that, when executed by the processor, configure the system to:
accept input from a user, the user input comprises a second value of each of the one or more parameters associated with an instant transaction;
access, using the network interface, the plurality of completed transactions from the database;
compare the first value to the second value; and
based on the comparison, automatically list the one or more documents of the plurality of documents.

12. The system of claim 11, wherein the user utilizes the one or more documents of the plurality of documents to complete the instant transaction.

13. The system of claim 11 further comprises a display screen with a graphic user interface (GUI), and the user utilizes the GUI to selectively accept or reject each listed document of the one or more documents of the plurality of documents.

14. The system of claim 13, wherein the user utilizes the GUI to selectively access each of the plurality of documents.

15. The system of claim 13, wherein the selectively accepted one or more documents of the plurality of documents are used to complete the instant transaction.

16. The system of claim 15, wherein the selectively accepted one or more documents of the plurality of documents, the second value of each of the one or more parameters associated with the instant transaction, and the instant transaction are stored in the database for comparison during a future time period by the user, another user, or a combination thereof.

17. The system of claim 16, wherein the storing in the database increases an accuracy of the system to complete a future transaction in the future time period.

18. The system of claim 15, wherein the instant transaction occurs in a current time period, a future time period, a near future time period, or a combination thereof

19. The system of claim 11, wherein the user input further comprises a desired confidence threshold, the desired confidence threshold being between zero percent confidence and 100 percent confidence.

20. The system of claim 11 being used by a car dealership.
